(19) United States
(12) Patent Application Publication
(10) Pub. No.: US 2024/0186572 A1
(43) Pub. Date: Jun. 6, 2024

(54) Solid-Liquid Composite Electrolyte Including Sulfide-based Solid Electrolyte and High-kosmotropicity Salt-containing Liquid Electrolyte, and Semi-solid-state Rechargeable Batteries

(71) Applicant: UIF (University Industry Foundation), Yonsei University, Seoul (KR)

(72) Inventors: Sang-Young Lee, Seoul (KR); Won-Yeong Kim, Seoul (KR); Kyeong-Seok Oh, Seoul (KR); Seokhyeon Yu, Seoul (KR)

(21) Appl. No.: 18/523,235

(22) Filed: Nov. 29, 2023

(30) Foreign Application Priority Data
Dec. 1, 2022 (KR) 10-2022-0166000
Sep. 19, 2023 (KR) 10-2023-0124943

(51) Int. Cl. H01M 10/0562; H01M 10/0568; H01M 10/0569

(52) U.S. Cl. CPC H01M 10/0562; H01M 10/0568; H01M 10/0569; H01M 2300/008

(57) ABSTRACT

Disclosed are includes a solid-liquid composite electrolyte, and a composite electrolyte film, and a semi-solid rechargeable battery including the same, the solid-liquid composite electrolyte including a sulfide-based solid electrolyte and a liquid electrolyte, wherein the liquid electrolyte includes a salt and an organic solvent, the salt includes a metal cation and an anion with a radius of less than about 295 pm.

### CROSS-REFERENCE TO RELATED APPLICATION

This application claims priority to and the benefit of Korean Patent Application No. 10-2022-0166000 filed in the Korean Intellectual Property Office on Dec. 1, 2022, and Korean Patent Application No. 10-2023-0124943 filed in the Korean Intellectual Property Office on Sep. 19, 2023, the entire contents of which are incorporated herein by reference.

### BACKGROUND OF THE INVENTION

### (a) Field of the Invention

A solid-liquid composite electrolyte including a sulfide-based solid electrolyte and a kosmotropic salt-containing liquid electrolyte, and a semi-solid rechargeable battery are disclosed.

### (b) Description of the Related Art

General rechargeable batteries use a flammable electrolyte and have a safety issue such as explosion or fire, when problems such as collision or penetration, etc. occur. Accordingly, all-solid rechargeable batteries or semi-solid rechargeable batteries using a solid electrolyte instead of an electrolyte solution are being proposed. The batteries using solid electrolytes are safe with no risk of explosion due to electrolyte leakage and have an advantage of being easily manufactured into thin batteries, in which a negative electrode thickness may be reduced, improving rapid charging and discharging performance and realizing high-voltage driving and high energy density. In particular, sulfide-based solid electrolytes have recently attracted much attention due to their high ionic conductivity comparable with liquid electrolytes and high transference number (t_{Li+}≈1).

However, the sulfide-based solid electrolyte has a problem of deterioration of ionic conductivity performance due to resistance generated on the interface with other solid particles such as a positive electrode active material and the like in the batteries and a depletion layer formed by joining the solids.

Accordingly, research on solving the problems of the solid electrolyte is underway by adding a liquid electrolyte to the sulfide-based solid electrolyte to prepare a solid-liquid composite electrolyte. However, conventional studies to combine the sulfide-based solid electrolyte with the liquid electrolyte have the following limitations. First, a chemical side reaction on the interface of the liquid electrolyte, which is generally highly polar, with the sulfide-based solid electrolyte, second, high resistance against movement of lithium ions on the interface of the liquid electrolyte with the sulfide-based solid electrolyte, third, deterioration of single ionic conductivity due to a low lithium ion yield (Li⁺ transference number) of the liquid electrolyte, forth, flame retardant loss due to introduction of the liquid electrolyte, which is flammable, into the sulfide-based solid electrolyte, and, and fifth, low high-voltage oxidation stability of conventional composite electrolytes, resulting in an unstable interface with a positive electrode.

### SUMMARY OF THE INVENTION

Some embodiments provide a solid-liquid composite electrolyte that can be applied to practical batteries by reducing side reactions between a sulfide-based solid electrolyte and a liquid electrolyte, maintaining high ionic conductivity, and ensuring oxidation stability, heat resistance, and flame retardancy, a composite electrolyte film and semi-solid rechargeable electrolyte including the same.

In some embodiments, a solid-liquid composite electrolyte includes a sulfide-based solid electrolyte and a liquid electrolyte, wherein the liquid electrolyte includes a metal salt and an organic solvent, and the salt includes a metal cation and an anion with a radius of less than about 295 pm.

Some embodiments provide a composite electrolyte film including the solid-liquid composite electrolyte.

Some embodiments provide a semi-solid rechargeable battery including a positive electrode, a negative electrode, and the solid-liquid composite electrolyte.

The solid-liquid composite electrolyte according to some embodiments has fewer side reactions between the sulfide-based solid electrolyte and the liquid electrolyte, can maintain high ionic conductivity, and has oxidation stability, heat resistance, and flame retardancy at the same time, so it can be applied to practical batteries and improves reliability and cycle-life characteristics of the battery.

### BRIEF DESCRIPTION OF THE DRAWINGS

FIG. 1 is an image schematically showing a semi-solid rechargeable battery according to some embodiments.

FIG. 2 is a photograph of the appearance of the solid-liquid composite electrolyte of Comparative Example 1.

FIG. 3 is a photograph of the appearance of the solid-liquid composite electrolyte of Example 1.

FIG. 4 is a graph showing the change in resistance over time for the solid-liquid composite electrolyte of Comparative Example 1.

FIG. 5 is a graph showing the change in resistance over time for the solid-liquid composite electrolyte of Example 1.

FIG. 6 is a graph showing the change in ionic conductivity over time for the solid-liquid composite electrolytes of Comparative Example 1 and Example 1.

FIG. 7 is a graph showing the change in current density according to voltage for the solid-liquid composite electrolytes of Example 1, Comparative Example 2, and Comparative Example 3.

### DETAlLED DESCRIPTION OF THE EMBODIMENTS

Hereinafter, specific embodiments will be described in detail so that those skilled in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by a transmission electron microscopic image or a scanning electron microscopic image. Alternatively, it is possible to obtain an average particle diameter value by measuring it using a dynamic light scattering method, performing data analysis, counting the number of particles for each particle size range, and calculating from this. As used herein, when a definition is not otherwise provided, the average particle diameter may mean a diameter (D₅₀) of particles having a cumulative volume of 50 vol % in a particle size distribution. As used herein, when a definition is not otherwise provided, the average particle diameter means a diameter (D₅₀) of particles having a cumulative volume of 50 vol % in the particle size distribution that is obtained by measuring the size (diameter or length of the major axis) of about 20 particles at random in a scanning electron microscope image.

Herein, “or” is not to be construed as an exclusive meaning, for example, “A or B” is construed to include A, B, A+B, and the like.

“Metal” is interpreted as a concept that includes ordinary metals, transition metals, and metalloids (semi-metals).

### Solid-Liquid Composite Electrolyte

A solid-liquid composite electrolyte according to some embodiments includes a sulfide-based solid electrolyte and a liquid electrolyte, wherein the liquid electrolyte includes a salt and an organic solvent, and the salt includes a metal cation and an anion with a radius of less than about 295 pm.

The solid-liquid composite electrolyte is a composite of the solid electrolyte and the liquid electrolyte and may be expressed as a hybrid electrolyte or a mixed electrolyte, etc. The solid electrolyte and the liquid electrolyte may be physically mixed or chemically bonded to each other. For example, the liquid electrolyte may be disposed in pores between a plurality of solid electrolyte particles. Or the liquid electrolyte may be located on the surface of the solid electrolyte particles and may be attached, adsorbed, connected, or bonded to at least a portion of the surface of the solid electrolyte particles, for example, surround the surface of the solid electrolyte particles in the form of a film.

### Liquid Electrolyte

In the solid-liquid composite electrolyte according to some embodiments, the liquid electrolyte includes a salt and an organic solvent, wherein the salt metal may be composed of a cation and an anion paired therewith, and the anion is characterized to have a radius of less than about 295 pm. The unit of pm is a picometer, wherein 1 pm is 10-12 m.

The biggest problem in combining the sulfide-based solid electrolyte and the liquid electrolyte is that the sulfide-based solid electrolyte and the liquid electrolyte chemically react to form a resistance layer, which reduces ionic conductivity. The liquid electrolyte includes a solvent, which is mainly polar, and this polar solvent strongly interacts with the sulfide-based solid electrolyte and thus easily causes a side reaction. For example, when a liquid electrolyte prepared by dissolving 1 M LiPF₆ in a carbonate-based solvent such as ethylene carbonate or propylene carbonate, etc. is combined with the sulfide-based solid electrolyte, since the liquid electrolyte and the solid electrolyte have high reactivity, which may cause a side reaction to form a resistance layer, ionic conductivity is rapidly deteriorated as reaction time goes.

Accordingly, recent studies have been conducted in the direction of selecting a nonpolar solvent rather than the polar solvent or a solvent having chemical stability with the sulfide-based solid electrolyte. For example, attempts have been proposed to combine a liquid electrolyte prepared by dissolving 1 M LiTFSI in a glyme-based solvent such as triethylene glycol dimethyl ether and the like with the sulfide-based solid electrolyte. However, the ionic conductivity deterioration over the reaction time has not been significantly improved.

Furthermore, attempts to combine a highly concentrated liquid electrolyte prepared by mixing the glyme based solvent and a lithium salt such as LiTFSI, LiBETI, and the like in a mole ratio of about 1:1 with the sulfide-based solid electrolyte have been proposed. Herein, there has been advantages of reducing the side reaction between the liquid electrolyte and the sulfide-based solid electrolyte and securing chemical stability but problems of deteriorating oxidation stability and thus causing an unstable interface of the sulfide-based solid electrolyte with a positive electrode at a high voltage and deteriorating or losing flame retardancy and heat resistance, which are advantages of the solid electrolyte and so, still limitations in application to actual batteries.

Accordingly, the present invention is to propose a composite electrolyte applicable to the actual batteries by securing high voltage oxidation stability, the heat resistance, and the flame retardancy as well as suppressing the side reaction between the sulfide-based solid electrolyte and the liquid electrolyte.

### Salt

Some embodiments are to suggest a direction of preparing a successful composite electrolyte by considering the Hofmeister effect of a salt, that is, controlling an interaction between the salt and an organic solvent in the liquid electrolyte. The embodiments are to select a kosmotropic anion as an anion forming the salt in the liquid electrolyte, that is, to design an anion with high kosmotropicity. The kosmotropic means “order” in Greek, which is the opposite concept of chaotropic. The higher kosmotropicity of the anion, the higher charge density and static electricity potential, which lead to the stronger interaction with the solvent, wherein the anion may not be rather dissolved in the solvent but tends to be salted out or aggregated. In other words, the anion with high kosmotropicity according to some embodiments has strong interaction energy with the solvent, the large solvation number of the anion, and a short bonding distance with the solvent. The anion with high kosmotropicity strongly attracts the solvent, which may deteriorate activity of the solvent and thereby effectively suppress a reaction between the solvent and the sulfide-based solid electrolyte. When the kosmotropic anion is applied, the chemical reaction of the liquid electrolyte and the sulfide-based solid electrolyte may be effectively suppressed even at a relatively low concentration of the salt.

In some embodiments, an anion having a radius of less than about 295 pm is proposed as a kosmotropic anion appropriately applicable to the solid-liquid composite electrolyte. When a liquid electrolyte including a salt, which consists of the anion having a radius of less than about 295 pm and a metal cation, and an organic solvent is combined with the sulfide-based solid electrolyte, the corresponding anion has strong interaction with the organic solvent and thereby suppresses the side reaction of the organic solvent with the sulfide-based solid electrolyte, significantly less deteriorating ionic conductivity over time and furthermore, securing high voltage oxidation stability. In addition, when the anion is applied, since types of the organic solvent is not limited, a solvent securing heat resistance and flame retardancy may be introduced. Accordingly, the composite electrolyte according to some embodiments may be suitable for introduction into actual batteries.

The type of anion of the salt according to some embodiments is not limited as long as the anion has a radius of less than about 295 pm. One type of salt may be used, or a mixture of two or more types of salts may be used. The radius of the anion may be, for example, less than or equal to about 290 pm, less than or equal to about 283 pm, less than or equal to about 270 pm, less than or equal to about 250 μm, or less than or equal to about 240 pm, for example, about 100 pm to about 290 pm, or about 160 pm to about 240 pm.

According to some embodiments, the anion satisfying a radius of less than about 295 pm may be, for example, Cl⁻, CH₃COO⁻, NO₃⁻, BF₄⁻, ClO₄⁻, SO₄₂⁻, OTf⁻, FSI⁻, or a combination thereof. As a specific example, the anion may be Cl⁻, CH₃COO⁻, NO₃⁻, BF₄⁻, ClO₄⁻, SO₄₂⁻, or a combination thereof. As a more specific example, the anion may be NO₃⁻, BF₄⁻, ClO₄⁻, or a combination thereof or BF₄⁻, ClO₄⁻, or a combination thereof.

The anion according to some embodiments may be an anion having a smaller radius than that of PF₆⁻. Referring to “Y. Marcus et al., J. Phys. Chem. B, 2014, 118, 8, 2172 to 2175,” PF₆⁻ has a radius of about 295 pm, ClO₄⁻ has a radius of about 240 pm, SO₄²⁻, BF₄⁻ have a radius of about 230 μm, and NO₃⁻ has a radius of about 179 pm. In addition, referring to “O. Shirai et al., Anal. Sci, 2009, 25, 189 to 193,” Cl⁻ has a radius of about 181 pm. Referring to “F. Sagane et al., Electrochemistry, 2022, 90, 037001,” TFSI⁻ has a radius of about 325 pm, and OTf⁻ has a radius of about 270 pm. Referring to “Y. Tominaga et al., J. Electrochem. Soc. 2015, 162, A3133,” FSI⁻ has a radius of about 283 pm, and referring to “I. Popovic et al., New J. Chem. 2016, 40, 1618 to 1625,” CH₃COO⁻ has a radius of about 162 pm.

A method of measuring the anion radius may not be limited to one theory but may be measured, for example, in a method proposed in “Y. Marcus et al., J. Phys. Chem. B, 2014, 118, 8, 2172 to 2175”.

According to some embodiments, the anion with the specific radius has high kosmotropicity and thus high charge density and static electricity potential and may strongly interact with a solvent. This anion strongly attracts an organic solvent and thus may suppress the side reaction between the organic solvent and the sulfide-based solid electrolyte, improving ionic conductivity of the composite electrolyte and securing oxidation stability, heat resistance, and flame retardancy.

The anion according to some embodiments may have radial charge density of, for example, less than about −5.44, for example, less than or equal to about −5.5, about −20 to about −5.5, or about −11 to about −5.5, wherein a unit may be about 10⁻¹⁰ C/m. The charge density may be described in “A. J. Page et al., Chem. Sci, 2021, 12, 15007”. The anion, which has charge density within the ranges, exhibits high kosmotropicity and strong interaction with a solvent and thus may effectively suppress a side reaction between the solvent and the sulfide-based solid electrolyte and in addition, even though used at a lower concentration and used even with a solvent with high polarity, may increase an ionic conductivity maintenance rate of the composite electrolyte and secure oxidation safety, heat resistance, flame retardancy, which is advantageous for application to actual batteries.

The anion according to some embodiments has a molecule polarity index (MPI) of greater than about 3.67, for example, greater than or equal to about 4, or about 4 to about 10, or about 4.2 to about 6.1, wherein a unit is eV. The molecule polarity index may be described in “A. Grimaud et al., J. Phys. Chem. B, 2021, 125, 5365 to 5372.”

The anion, which has MPI within the ranges, exhibits high kosmotropicity and strong interaction with a solvent and may effectively prevent the side reaction between the solvent and the sulfide-based solid electrolyte, and even if used at a lower concentration and used even with a solvent having high polarity, may increase the ionic conductivity maintenance rate of the composite electrolyte and secure oxidation safety, heat resistance, and flame retardancy, which is advantageous for application to actual batteries.

The metal cation that pairs with the anion in the salt is not particularly limited in type, and may be, for example, Li⁺, Na⁺, K⁺, Mg²⁺, Al³⁺, Zn²⁺, or a combination thereof, and may be, for example, an alkali metal cation, for example, Li⁺ or Na⁺.

The salt may be, for example, an alkali metal salt, a lithium salt or a sodium salt.

The salt may include, for example, a compound represented by Chemical Formula 1, a compound represented by Chemical Formula 2, or a combination thereof.

M¹X¹ [Chemical Formula 1]

In Chemical Formula 1, M¹ is Li⁺ or Na⁺, and X¹ is a monovalent anion with a radius of less than about 295 pm.

M²²X² [Chemical Formula 2]

In Chemical Formula 2, M² is Li⁺ or Na⁺, and X² is a divalent anion with a radius of less than 295 pm.

In Chemical Formula 1, X¹ may be, for example, Cl⁻, CH₃COO⁻, NO₃⁻, BF₄⁻, or ClO₄⁻. In Chemical Formula 2, X² may be, for example, SO₄²⁻.

### Organic Solvent

In the solid-liquid composite electrolyte according to some embodiments, the type of organic solvent of the liquid electrolyte is not particularly limited. Both highly polar solvents and solvents with low or no polarity can be used. For example, the highly polar solvent may have high reactivity with the solid electrolyte, causing a side reaction and forming a resistance layer, which may reduce ionic conductivity. However, when using a salt according to some embodiments, even if a polar solvent is used, a strong interaction between the anion of the salt and the organic solvent is exhibited, and thereby chemical side reactions between the organic solvent and the solid electrolyte can be effectively suppressed.

The organic solvent may include, for example, a carbonate-based solvent, an ester-based solvent, an ether-based solvent, a ketone-based solvent, an alcohol-based solvent, an aprotic solvent, or a combination thereof. The organic solvent may be used one type or in a mixture of two or more types.

The carbonate-based solvent may be a cyclic carbonate, a chain carbonate, or a combination thereof. The carbonate-based solvent is often polar, but when used together with anions according to some embodiments, they show strong interaction with the anions and chemical reactions with the solid electrolyte may be suppressed. Accordingly, the ionic conductivity of the solid-liquid composite electrolyte can be improved, advantages of carbonate-based solvents, such as oxidation stability, heat resistance, and flame retardancy, can be secured, and lithium metal stability and single ionic conductivity can be improved, making it possible to apply it to actual batteries.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or a combination thereof.

In one example, the carbonate-based solvent may include vinylene carbonate or an ethylene carbonate-based compound. The ethylene carbonate-based compound may include, for example, fluoroethylene carbonate, difluoroethylene carbonate, chloroethylene carbonate, dichloroethylene carbonate, bromoethylene carbonate, dibromoethylene carbonate, nitroethylene carbonate, cyanoethylene carbonate, or a combination thereof. As an example, the ethylene carbonate-based compound may be a halogenated ethylene carbonate, such as fluoroethylene carbonate, difluoroethylene carbonate, chloroethylene carbonate, dichloroethylene carbonate, bromoethylene carbonate, dibromoethylene carbonate, or a combination thereof.

The ester-based solvents may include, for example, methyl acetate, ethyl acetate, n-propyl acetate, dimethyl acetate, methyl propionate, ethyl propionate, y-butyrolactone, decanolide, valerolactone, valonolactone, valerolactone, caprolactone, or a combination thereof.

The ether-based solvents may include, for example, dibutyl ether, monoglyme, diglyme, triglyme, tetraglyme, dimethoxyethane, 2-methyltetrahydrofuran, 2,5-dimethyltetrahydrofuran, tetrahydrofuran, or a combination thereof.

For example, the ether-based solvent may include a glyme-based solvent, a halogenated ether-based solvent, or a combination thereof. The halogenated ether-based solvent may be, for example, a fluorinated ether containing one or more fluorines.

The ketone-based solvent may include, for example, cyclohexanone. The alcohol-based solvent may include, for example, ethyl alcohol, isopropyl alcohol, or a combination thereof.

The aprotic solvent may include, for example, nitriles such as R—CN (R is a C2 to C20 linear, branched, or ring-structured hydrocarbon group and may include a double bond, aromatic ring, or ether group); amides such as dimethylformamide; dioxolanes such as 1,3-dioxolane and 1,4-dioxolane; sulfolanes; or a combination thereof.

Among the aprotic solvents, nitrile-based solvents may include, for example, succinonitrile, adiponitrile, suberonitrile, sebaconitrile, decanedinitrile, dodecanedinitrile, or a combination thereof.

For example, the organic solvent may include a carbonate-based solvent, an ether-based solvent, a nitrile-based solvent, or a combination thereof. Specifically, the organic solvent may include a cyclic carbonate-based solvent, a halogenated ethylene carbonate-based solvent, a glyme-based solvent, a halogenated ether-based solvent, a nitrile-based solvent, or a combination thereof. These organic solvents have good miscibility with the aforementioned salt and can improve the ionic conductivity of the composite electrolyte while simultaneously securing oxidation stability, heat resistance, and flame retardancy, and are advantageous for application to actual batteries.

In some embodiments, a concentration of the liquid electrolyte is not particularly limited. A concentration of the liquid electrolyte can also be expressed as a concentration of the salt. In the past, attempts have been made to increase a concentration of the salt in order to lower the activity of the solvent, thereby increasing the concentration of the solvent and the salt to a mole ratio of almost 1:1. However, when an anion according to some embodiments is applied, ionic conductivity can be increased by sufficiently lowering the activity of the solvent even at a low concentration. Of course, the liquid electrolyte according to some embodiments may be designed to have a high concentration.

For example, the molal concentration of the liquid electrolyte according to some embodiments may be about 0.5 m to about 20 m, for example, about 0.5 m to about 18 m, about 0.5 m to about 15 m, about 0.5 m to about 11 m, about 0.5 m to about 10 m, about 0.5 m to about 8 m, about 0.5 m to about 7 m, or about 1 m to about 5 m.

### Sulfide-Based Solid Electrolyte

The sulfide-based solid electrolyte can be divided into crystalline and non-crystalline types depending on the presence or absence of a crystal structure.

The crystalline types may include Thio-LISICON such as Li_{3.25}Ge_{0.25}P_{0.75}S₄, LGPS such as Li₁₀GeP₂S₁₂, and argyrodite structures such as Li₆PS₅Cl. The non-crystalline types may be divided into glass types and glass-ceramic types depending on the difference in heat treatment temperature. The glass types may include, for example, 30Li₂S.26B₂S₃·44LiO, 63Li₂S·36SiS₂·1Li₃PO₄, 57Li₂S·38SiS₂·5Li₄SiO₄, etc. and glass-ceramic types may include, for example, Li_{3.25}P_{0.95}S₄, Li₇P₃S₁₁.

The glass-type sulfide-based solid electrolyte, which has been actively researched by Professor Hayashi's research group in Japan, who has reported that high ionic conductivity of about 10-3 S/cm may be realized by mixing Li₂S₅ and P₂S₅ in a ratio of about 7:3, amorphizing them through high-energy ball milling to form a glass-type solid electrolyte, and heat-treating the glass-type solid electrolyte at a low temperature to synthesize a glass-ceramic-type electrolyte.

LGPS, one of the crystalline sulfide-based electrolytes, has been reported to exhibit high ionic conductivity of about 1.2×10⁻² S/cm at room temperature. After the report about LGPS, research on substituting Ge with Si, Sn, and Al or S with Se and the like has been explosively carried out, but all of the resultants exhibited no higher ionic conductivity than that of LGPS but had economic advantages. In addition, argyrodite type Li_{9.54}Si_{1.74}P_{1.44}S_{11.7}C_{10.3}, which has been reported in 2016, has recorded ionic conductivity of about 2.5×10⁻² S/cm or so, which is at the same level as that of a liquid electrolyte.

Through these various studies, the sulfide-based solid electrolyte has shown progress in improving ionic conductivity. In addition, the sulfide-based solid electrolyte has high thermal safety and is less likely to cause fire by thermal runaway. Nevertheless, the sulfide-based solid electrolyte has high reactivity with moisture and thus exhibits poor stability in the air such as formation of H₂S when exposed to the air. In addition, the sulfide-based solid electrolyte has an unstable interface in contact with a positive electrode active material and thus deteriorates cycle-life characteristics and furthermore, since it is solid, may have inevitable interfacial resistance with an electrode. For this reason, various studies for improving reactivity and interface stability of the sulfide-based solid electrolyte with moisture as well as ionic conductivity and commercializing it are being conducted.

The sulfide-based solid electrolyte may be classified into a binary structure such as an argyrodite structure, Li₂S—P₂S₅, and the like, a ternary structure such as Li₂S—GeS₂—P₂S₅ and the like, etc.

The argyrodite-type solid electrolyte is one of the solid electrolytes having the same structure as Ag₉GeS₆, an ore, and exhibiting lithium ionic conductivity. Representative Li-argyrodites having Li⁺ conductivity include Li₇PS₆ and Li₆PS₅X (X=Cl, Br, or I). A method of synthesizing the argyrodite-type sulfide-based solid electrolyte in general includes mechanical milling, annealing after milling, solid sintering, a liquid method, and the like. However, the argyrodite type sulfide-based solid electrolyte is sensitive to air and humidity and thus may require difficult synthesis conditions and have a safety issue due to the use of an organic solvent and also, a problem of deteriorating electrolyte performance due to low solubility in reactants and an incomplete reaction mechanism.

One of the argyrodite types, Li₇PS₆, has been reported to have a cubic phase at a high temperature and an orthorhombic phase at a low temperature, wherein the cubic phase at a high temperature may have much improved ionic conductivity. This compound may be stabilized by replacing sulfur with a halogen anion. When substituted with the halogen element, since vacancy is formed at lithium sites inside argyrodite unit cells, lithium ionic conductivity is improved, and in addition, since the cubic phase is stabilized even at room temperature due to the substitution of the halogen ion, for example, Li₆PS₅Br and Li₆PS₅Cl may exhibit high ionic conductivity of about 10-3 S/cm or more. The argyrodite type sulfide-based solid electrolyte may include, for example, Li₇PS₅Br, Li₅PS₄Cl₂, Li₆PS₅Cl, Li₆PS₅Br, Li₆PS₅I, Li₄P₂S₆l, Li₄PS₄l, Li_{9.54}Si_{1.74}P_{1.44}S_{11.7}C_{10.3}, Li₇P_{2.9}M_{10.1}S_{10.7}l_{0.3}, or a combination thereof but is not limited thereto.

The sulfide-based solid electrolyte is in the form of particles, and an average particle diameter (D50) of the sulfide-based solid electrolyte particle may be less than or equal to about 5.0 μm, for example, about 0.1 μm to about 5.0 μm, about 0.5 μm to about 5.0 μm, about 0.5 μm to about 4.0 μm, about 0.5 μm to about 3.0 μm, about 0.5 μm to about 2.0 μm, or about 0.5 μm to about 1.0 μm. Such a sulfide-based solid electrolyte may effectively penetrate between the positive active materials, and have excellent contact properties with the positive active material and connectivity between the solid electrolyte particles.

The solid-liquid composite electrolyte according to some embodiments may further include other types of solid electrolytes in addition to the sulfide-based solid electrolyte, and may further include, for example, an oxide-based solid electrolyte, a halide-based solid electrolyte, a complex hydride, or a combination thereof.

The oxide-based inorganic solid electrolyte may include, for example, Li₁₊ₓTI₂₋ₓAl(PO₄)₃ (LTAP) (0≤x≤4), Li_{1+x+y}AlₓTi₂₋ₓSi_{y}P_{3-y}O₁₂(0<x<2, 0≤y<3), BaTiO₃, Pb(Zr, Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al,Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet type ceramics Li₃₊ₓLa₃M₂O₁₂ (M=Te, Nb, or Zr, and x is an integer of 1 to 10), or a combination thereof.

The halide-based solid electrolyte includes a halogen element as a main component, and a ratio of the halogen element to all elements constituting the solid electrolyte may be greater than or equal to about 50 mol %, greater than or equal to about 70 mol %, greater than or equal to about 90 mol %, or 100 mol %. As an example, the halide-based solid electrolyte may not contain elemental sulfur.

The halide-based solid electrolyte may contain a lithium element, a metal element other than lithium, and a halogen element. The metal element other than lithium may be, for example, Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof, and for example, it may be Cl, Br, or a combination thereof. The halide-based solid electrolyte may be, for example, LiₐM₁X₆ (M is Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X is F, Cl, Br, I, or a combination thereof, and 2≤a≤3). The halide-based solid electrolyte may include, for example, Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof.

The complex hydride may be, for example, composed of a metal cation (M) and a complex-anion in the form of M′Hn (MM′Hn). The metal cation (M) may be, for example, Li, Na, K, Mg, Sc, Cu, Zn, Zr, or Hf, and the complex-anion may be [BH₄]⁻, [NH₂]⁻, [AlH₄]⁻, [NH]²⁻, [AlH₆]³⁻, or [NiH₄]⁴⁻. The complex hydride may refer to “M. Matsuo, S.-i. Orimo, Adv. Energy Mater. 2011, 1, 161”.

In some embodiments, the sulfide-based solid electrolyte may be included in about 10 vol % to about 99.99 vol % and the liquid electrolyte may be included in about 0.01 vol % to about 90 vol % based on 100 vol % of the solid-liquid composite electrolyte. For example, based on 100 vol % of the solid-liquid composite electrolyte, the sulfide-based solid electrolyte may be included in an amount of about 30 vol % to about 99.99 vol %, about 40 vol % to about 99.99 vol %, about 50 vol % to about 99.99 vol %, about 60 vol % to about 99.99 vol %, about 70 vol % to about 99.9 vol %, about 80 vol % to about 99.5 vol %, about 90 vol % to about 99 vol %, about 95 vol % to about 98 vol %, or about 90 vol % to about 95 vol % and the liquid electrolyte may be included in an amount of about 0.01 vol % to about 70 vol %, about 0.01 vol % to about 60 vol %, about 0.01 vol % to about 50 vol %, about 0.01 vol % to about 40 vol %, about 0.1 vol % to about 30 vol %, about 0.5 vol % to about 20 vol %, about 1 vol % to about 10 vol %, about 2 vol % to about 5 vol %, or about 5 vol % to about 10 vol %.

A weight ratio of the sulfide-based solid electrolyte and the liquid electrolyte may vary depending on the concentration of the liquid electrolyte. For example, based on 100 wt % of the solid-liquid composite electrolyte, the sulfide-based solid electrolyte may be included in an amount of about 10 wt % to about 99.99 wt % and the liquid electrolyte may be included in an amount of about 0.01 wt % to about 90 wt %. For example, based on 100 wt % of the solid-liquid composite electrolyte, the sulfide-based solid electrolyte may be included in an amount of about 30 wt % to about 99.99 wt %, about 40 wt % to about 99.99 wt %, about 50 wt % to about 99.99 wt %, about 60 wt % to about 99.99 wt %, about 70 wt % to about 99.99 wt %, about 80 wt % to about 99.99 wt %, about 90 wt % to about 99.99 wt %, about 95 wt % to about 99.99 wt %, about 99 wt % to about 99.99 wt %, about 90 wt % to about 99.9 wt %, or about 90 wt % to about 99 wt % and the liquid electrolyte may be included in an amount of about 0.01 wt % to about 70 wt %, about 0.01 wt % to about 60 wt %, about 0.01 wt % to about 50 wt %, about 0.01 wt % to about 40 wt %, about 0.01 wt % to about 30 wt %, about 0.01 wt % to 20 wt %, about 0.01 wt % to about 10 wt %, about 0.01 wt % to about 5 wt %, about 0.01 wt % to about 1 wt %, about 0.1 wt % to about 10 wt %, or about 1 wt % to about 10 wt %.

If the content of the liquid electrolyte in the solid-liquid composite electrolyte is excessive, battery safety may not be guaranteed due to loss of flame retardancy due to the liquid electrolyte or an inherent risk of battery explosion, and if the content of the liquid electrolyte is too low, the disadvantages of sulfide-based solid electrolytes cannot be overcome and ionic conductivity may decrease or cycle-life characteristics may deteriorate. When the sulfide-based solid electrolyte and liquid electrolyte satisfy the above-mentioned content range, solid and liquid can be easily combined, high ionic conductivity can be maintained, and battery safety can be ensured.

In some embodiments, the liquid electrolyte, which is applied in a very small content to that of the sulfide-based solid electrolyte, may effectively solve the problems of the ionic conductivity deterioration, the resistance increase, and the like due to the sulfide-based solid electrolyte and also, realize high voltage oxidation stability, flame retardancy, and safety as well as an excellent ionic conductivity maintenance rate. For example, when the liquid electrolyte is included in an amount of less than or equal to about 10 vol %, less than or equal to about 5 vol %, or less than or equal to about 1 vol % based on 100 vol % of the solid-liquid composite electrolyte, the sulfide-based solid electrolyte and the liquid electrolyte may be easily combined, improving ionic conductivity, oxidation safety, and cycle-life characteristics by the liquid electrolyte of some embodiments as well as securing safety of the sulfide-based solid electrolyte.

### Other Components

The composite electrolyte according to some embodiments may further include other types of a salt, a binder, an organic dispersant, ionic liquid, a conductive polymer, additives, etc. in addition to the aforementioned salt and organic solvent.

The binder may include, for example a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polybutadiene, polydimethylsiloxane, polyethyleneoxide, polyvinylpyrrolidone, polyvinylpyridine, chlorosulfonatedpolyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, or a combination thereof.

The ionic liquid has a melting point below room temperature, so it is in a liquid state at room temperature and refers to a salt or room temperature molten salt composed of ions alone. The ionic liquid may include at least one cation selected from a) ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, and triazolium-based cations, and at least one anion selected from b) BF₄⁻, PF₆⁻, AsF₆⁻, SbF₆⁻, AlCl₄⁻, HSO₄⁻, ClO₄⁻, CH₃SO₃, CF₃CO₂, Cl⁻, Br⁻, I⁻, BF₄⁻, SO₄⁻, CF₃SO₃⁻, FSO₂₂N⁻, (C₂F₅SO₂)₂N⁻, (C₂F₅SO₂, CF₃SO₂)N⁻, and (CF₃SO₂)₂N⁻. The ionic liquid may include, for example, one or more selected from N-methyl-N-propylpyrroldinium bis(trifluoromethanesulfonyl)imide, N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

The solid-liquid composite electrolyte according to some embodiments may be in the form of a type of pellet or a film. The solid-liquid composite electrolyte can be applied to various positions in the battery. For example, it may be mixed with a positive electrode active material to form a positive electrode, a solid electrolyte film, or mixed with a negative electrode active material to form a negative electrode.

### Composite Electrolyte Film

Some embodiments provide a composite electrolyte film including the above solid-liquid composite electrolyte. The composite electrolyte film may have, for example, a thickness of about 20 μm to about 1000 μm, about 20 μm to about 800 μm, about 20 μm to about 700 μm, or about 20 μm to about 600 μm. The composite electrolyte film according to some embodiments is disposed between positive and negative electrodes and thus may secure battery safety as well as realize high ionic conductivity and thereby, improve cycle-life characteristics and rate capabilities of a battery.

### Semi-Solid Rechargeable Battery

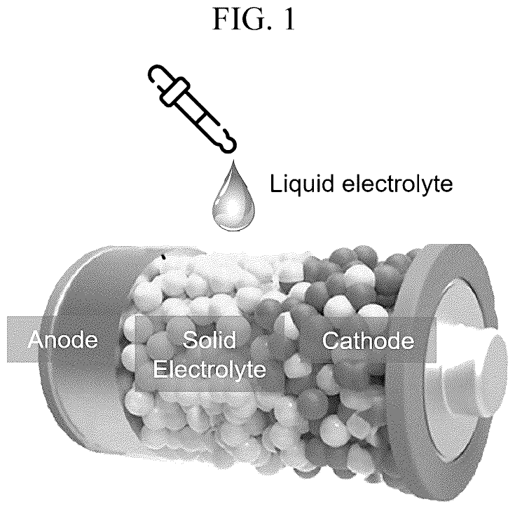

Some embodiments provide a semi-solid rechargeable battery including a positive electrode, a negative electrode, and the aforementioned composite electrolyte film between the positive electrode and the negative electrode. For easy understanding, a shape of a semi-solid rechargeable battery according to some embodiments is shown in FIG. 1. Although FIG. 1 shows one electrode assembly including the negative electrode, composite electrolyte film, and positive electrode, a semi-solid rechargeable battery can also be manufactured by stacking two or more electrode assemblies.

### Negative Electrode

The negative electrode may be a general negative electrode containing various negative electrode active materials such as carbon-based, silicon-based, etc.; it may be a negative electrode made of metal such as lithium metal; or it may be a precipitated negative electrode that acts as a negative electrode active material wherein the negative electrode active material is not initially present, but lithium metal, etc. is precipitated during charging.

As an example, the negative electrode may include a current collector and a negative electrode active material layer on the current collector. The negative electrode active material layer includes a negative electrode active material, may further include a binder and/or a conductive material, and may optionally include the aforementioned composite electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative active material. Examples of crystalline carbon may include natural graphite, artificial graphite, or a combination thereof, and examples of amorphous carbon include soft carbon or hard carbon, a mesophase pitch carbonized product, and calcined coke. The carbon-based negative electrode active material may be irregular-shaped, plate-shaped, flake-shaped, spherical, or fibrous.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative active material or a Sn-based negative active material. The Si-based negative active material may include silicon, a silicon-carbon composite, SiOₓ (0<x<2), a silicon alloy, and the like and the Sn-based negative active material may include Sn, SnO₂, a tin alloy, and the like. At least one of these materials may be mixed with SiO₂. For example, the negative electrode active material may include a composite of silicon and carbon.

The binder may be a water-insoluble binder, a water-soluble binder, or a combination thereof.

The water-insoluble binder may include polyvinylchloride, carboxylated polyvinylchloride, polyvinylfluoride, an ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may include a rubber binder or a polymer resin binder. The rubber-based binder may be selected from a nitrile butadiene rubber, a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, polybutadiene, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound may be further included as a type of thickener. As the cellulose-based compound, one or more of carboxymethyl cellulose, hydroxypropylmethyl cellulose, methyl cellulose, or alkali metal salts thereof may be mixed and used. The alkali metal may be Na, K, or Li.

The conductive material may be, for example, a carbon-based material such as natural graphite, artificial graphite, carbon black, acetylene black, ketjen black, a carbon fiber, a carbon nanofiber, or a carbon nanotube; a metal-based material of a metal powder or a metal fiber including copper, nickel, aluminum silver, and the like; or a conductive polymer such as a polyphenylene derivative; or a mixture thereof.

### Positive Electrode

The positive electrode may include a current collector and a positive electrode active material layer on the current collector, and the positive electrode active material layer may include a positive electrode active material and optionally may include a solid electrolyte. The positive active material layer may optionally further include a binder and/or a conductive material.

### Positive Electrode Active Material

The positive electrode active material can be applied without limitation as long as it is commonly used in rechargeable batteries. For example, the positive electrode active material may be a compound capable of intercalating and deintercalating lithium, and may include, for example, a lithium transition metal composite oxide.

The positive electrode active material may include, for example, lithium nickel-based oxide, lithium cobalt-based oxide, lithium manganese-based oxide, lithium iron phosphate-based compound, cobalt-free nickel-manganese-based oxide, or a combination thereof, and may include, for example, lithium nickel oxide (LNO), lithium cobalt oxide (LCO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), lithium iron phosphate (LFP), or a combination thereof.

The positive electrode active material may be included in an amount of about 55 wt % to about 99.5 wt %, for example about 65 wt % to about 95 wt %, or about 75 wt % to about 91 wt % based on 100 wt % of the positive electrode active material layer.

### Binder

The binder serves to adhere the positive electrode active material particles to each other and to the current collector. Examples of the binder may include a nitrile butadiene rubber, polybutadiene, polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto. An amount of the binder in 100 wt % of the positive electrode active material layer may be approximately about 0.1 wt % to about 5 wt %.

### Conductive Material

The conductive material may include a carbon-based material such as natural graphite, artificial graphite, carbon black, acetylene black, ketjen black, a carbon fiber, a carbon nanofiber, carbon nanotube, and the like; a metal-based material of a metal powder or a metal fiber including copper, nickel, aluminum, silver, and the like; a conductive polymer such as a polyphenylene derivative; or a mixture thereof. In 100 wt % of the positive electrode active material layer, an amount of the conductive material may be about 0 wt % to about 3 wt %, or about 0.01 wt % to about 2 wt %.

The aforementioned composite electrolyte may be included in an amount of about 0.1 wt % to about 45 wt %, for example, about 1 wt % to about 35 wt %, about 5 wt % to about 30 wt %, about 8 wt % to about 25 wt %, or about 10 wt % to about 20 wt % based on 100 wt % of the positive electrode active material layer.

The shape of the semi-solid rechargeable battery is not particularly limited, and may be, for example, coin-shaped, button-shaped, sheet-shaped, stacked-shaped, cylindrical, etc. The semi-solid rechargeable battery according to some embodiments can be applied to various electronic devices, such as electric vehicles and power storage devices.

Hereinafter, examples of the present invention and comparative examples are described. It is to be understood, however, that the examples are for the purpose of illustration and are not to be construed as limiting the present invention.

### Example 1

150 mg of an argyrodite-type sulfide-based solid electrolyte (Li₆PS₅Cl) was prepared and pressed at 370 MPa for 1 minute and then, stabilized at 74 MPa for 12 hours to prepare a solid electrolyte pellet with a thickness of about 600 μm or less and an area of 1.33 cm².

A liquid electrolyte was prepared by dissolving LiBF₄ at a molal concentration of 4.3 m in an organic solvent of ethylene carbonate and propylene carbonate mixed in a volume ratio of 1:1.

40 μl of the liquid electrolyte was dropped on the solid electrolyte pellet and then maintained for 10 minutes to prepare a solid-liquid composite electrolyte. Herein, an amount of the liquid electrolyte was about 10 vol % based on 100 vol % of the solid-liquid composite electrolyte.

### Examples 2 to 7 and Comparative Examples 1 to 4

Each solid-liquid composite electrolyte was prepared in the same manner as in Example 1 except that types of organic solvents, types of salts, and concentrations were changed as shown in Table 1.

TABLE 1

| | Concentration | Salt | Organic solvent |
|---|---|---|---|
| Example 1 | 4.3m | LiBF₄ | EC/PC (1:1) |
| Example 2 | 4.3m | LiBF₄ | G1 |
| Example 3 | 6m | LiBF₄ | SBN |
| Example 4 | 7m | LiBF₄ | PC/FEC (93:7) |
| Example 5 | 4.3m | LiClO₄ | EC/PC (1:1) |
| Example 6 | 4.3m | LiClO₄ | PC/FEC (93:7) |
| Example 7 | 4.3m | LiNO₃ | G1 |
| Comparative Example 1 | 1M | LiTFSI | G3 |
| Comparative Example 2 | 4.3m | LiTFSI | EC/PC (1:1) |
| Comparative Example 3 | 5.6m | LiTFSI | G3 |
| Comparative Example 4 | 1M | LiPF₆ | EC/PC (1:1) |

In Table 1, EC indicates ethylene carbonate, PC indicates propylene carbonate, G3 indicates triethylene glycol dimethyl ether, G1 indicates ethylene glycol dimethyl ether, FEC indicates fluoroethylene carbonate, SBN indicates sebaconitrile, and LiTFSI indicates lithium bis(trifluoromethanesulfonyl)imide. In the concentration, the lowercase m indicates a molal concentration, while the uppercase M indicates a molar concentration. In the organic solvent, 1:1 and 93:7, etc. indicate a volume ratio.

### Evaluation Example 1: Change in Appearance of Composite Electrolyte

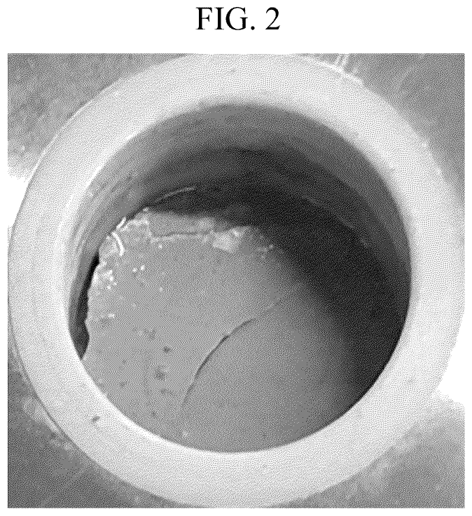

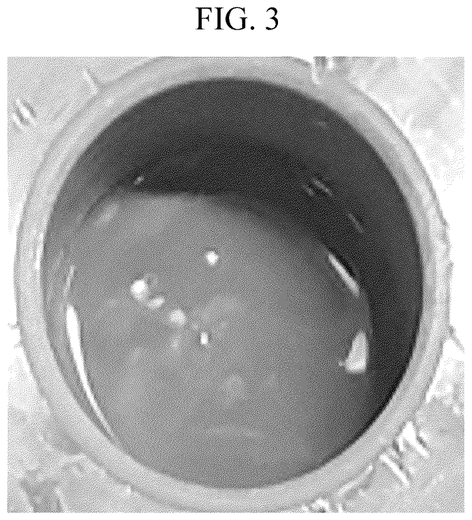

In Example 1 and Comparative Example 1, after examining appearance changes of each of the pellets after adding a liquid electrolyte to a solid electrolyte, a photograph of Comparative Example 1 is shown in FIG. 2, and a photograph of Example 1 is shown in FIG. 3. Comparative Example 1 of FIG. 2 exhibited cracks due to a side reaction, but Example 1 of FIG. 3 maintained a good appearance without cracks. The composite electrolyte of Example 1 was understood to maintain a stable hybrid electrolyte shape without a side reaction between solid and liquid.

### Evaluation Example 2: Evaluation of Resistance Changes and Ionic Conductivity Changes

The solid-liquid composite electrolytes of the examples and the comparative examples were measured with respect to resistance changes and ionic conductivity changes through electrochemical Impedance spectroscopy (EIS). EIS was performed for 0.5 to 72 hours in a state of pressurizing the solid-liquid composite electrolyte at 74 MPa and analyzed under an amplitude of about 10 mV at a frequency of 1 MHz to 100 mHz under an air atmosphere at 25° C.

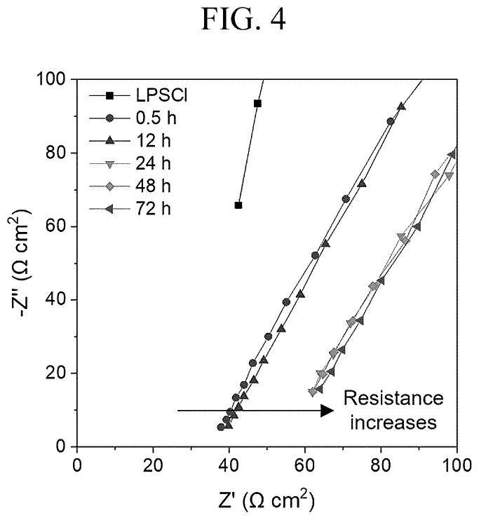

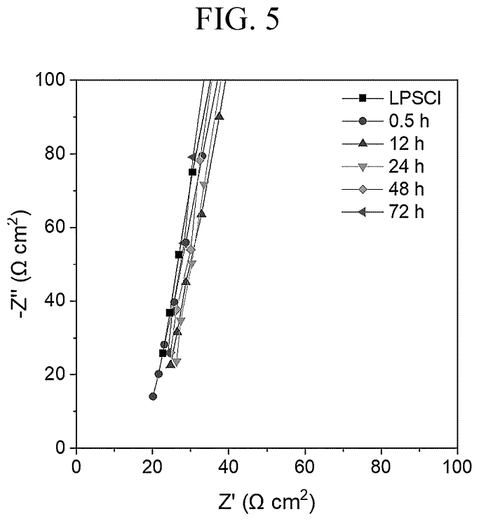

FIG. 4 is a graph showing resistance (Rb) changes of the composite electrolyte of Comparative Example 1 over time. Referring to FIG. 4, as reaction time increased, resistance increased. In Comparative Example 1, a side reaction between solid electrolyte and liquid electrolyte occurred over the reaction time, which formed a resistance layer. On the other hand, FIG. 5 is a graph showing resistance changes of the composite electrolyte of Example 1 over times, which confirmed that the resistance changes were insignificant over times. Example 1 was effectively suppressed from the side reaction between solid electrolyte and liquid electrolyte.

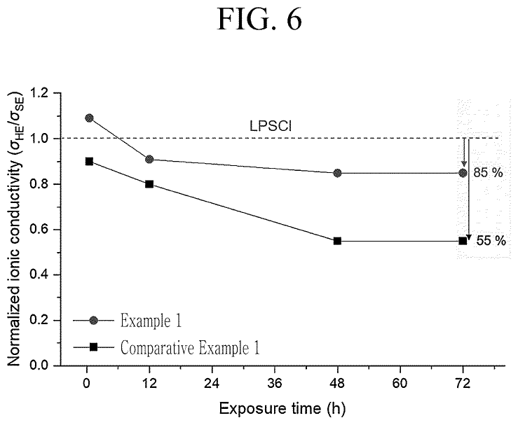

FIG. 6 is a graph showing ionic conductivity changes of Comparative Example 1 and Example 1. Herein, ionic conductivity was standardized as a ratio of ionic conductivity of a composite electrolyte to that of a solid electrolyte. Referring to FIG. 6, since Comparative Example 1 exhibited an ionic conductivity maintenance rate of 55% after 72 hours, while Example 1 exhibited an ionic conductivity maintenance rate of 85% after 72 hours, which confirmed that the ionic conductivity of Example 1 was improved. In general, ionic conductivity of the composite electrolyte is supposed to be deteriorated due to the side reaction of a solid electrolyte and a liquid electrolyte, but the ionic conductivity of Example 1 was significantly less deteriorated.

Table 2 shows a standardized ionic conductivity (CHE) as a ratio of the ionic conductivity (OSE) after 72 hours of a composite electrolyte to that of a solid electrolyte by measuring the ionic conductivity after 72 hours of each of the composite electrolytes of Examples 1 to 5 and Comparative Examples 1 to 4 after adding a liquid electrolyte to a solid electrolyte.

TABLE 2

| | | Normalized ionic |
|---|---|---|
| | | conductivity after 72 |
| | Liquid electrolyte | hours (σ_{HE}/σ_{SE}) |
| Example 1 | 4.3m LiBF₄ in EC/PC | 0.8485 |
| Example 2 | 4.3m LiBF₄ in G1 | 0.8452 |
| Example 3 | 6m LiBF₄ in SBN | 0.9581 |
| Example 4 | 7m LiBF₄ in PC/FEC | 0.9213 |
| Example 5 | 4.3m LiClO₄ in EC/PC | 0.9910 |
| Comparative Example 1 | 1M LiTFSI in G3 | 0.5500 |
| Comparative Example 2 | 4.3m LiTFSI in EC/PC | 0.7468 |
| Comparative Example 3 | 5.6m LiTFSI in G3 | 1.2507 |
| Comparative Example 4 | 1M LiPF₆ in EC/PC | 0.4038 |

Referring to Table 2, the examples exhibited much higher ionic conductivity after 72 hours than Comparative Examples 1, 2, and 4. In other words, the composite electrolytes of the examples exhibited less deteriorated ionic conductivity after 72 hours due to a smaller side reaction between solid and liquid electrolytes.

### Evaluation Example 3: Evaluation of Oxidation Stability

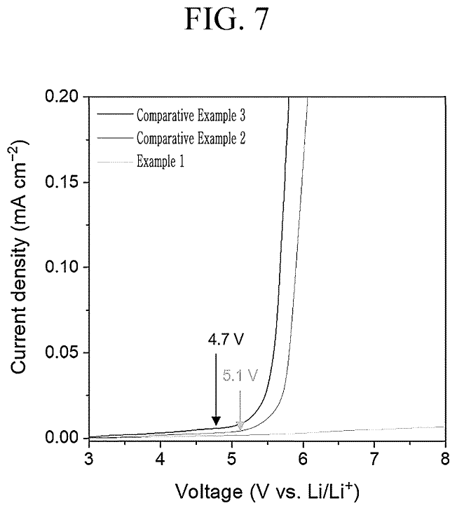

The composite electrolytes of Example 1 and Comparative Examples 2 and 3 were analyzed with respect to current density characteristics through a voltage through linear sweep voltammetry (LSV), and the results are shown in FIG. 7. Referring to FIG. 7, current density sharply increased at about 4.7 V in Comparative Example 3 and at about 5.1 V in Comparative Example 2, which show that high-voltage oxidation stability was deteriorated.

Comparative Example 3 exhibited relatively high ionic conductivity after 72 hours, and Comparative Example 2 exhibited higher ionic conductivity after 72 hours than Comparative Examples 1 and 4, but both of them exhibited extremely increased resistance at a high voltage of about 4.5 V or higher due to low oxidation stability and thus, may not be suitable for application to actual batteries. In addition, Comparative Examples 2 and 3 were expensive and uneconomical and thus had limitations in applicability to actual batteries.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A solid-liquid composite electrolyte, comprising
a sulfide-based solid electrolyte and a liquid electrolyte,
wherein the liquid electrolyte includes a salt and an organic solvent, and
the salt includes a metal cation and an anion with a radius of less than about 295 pm.

2. The solid-liquid composite electrolyte of claim 1, wherein
the radius of the anion in the salt is about 100 μm to about 290 pm.

3. The solid-liquid composite electrolyte of claim 1, wherein
the radius of the anion in the salt is about 160 pm to about 240 pm.

4. The solid-liquid composite electrolyte of claim 1, wherein
the anion in the salt is Cl⁻, CH₃COO⁻, NO₃⁻, BF₄⁻, ClO₄⁻, SO₄₂⁻, OTf⁻, FSI⁻, or a combination thereof.

5. The solid-liquid composite electrolyte of claim 1, wherein
the anion in the salt is BF₄⁻, ClO₄⁻, or a combination thereof.

6. The solid-liquid composite electrolyte of claim 1, wherein
the cation in the salt is Li⁺, Na⁺, K⁺, Mg²⁺, Al³⁺, Zn²⁺, or a combination thereof.

7. The solid-liquid composite electrolyte of claim 1, wherein
the salt includes a compound represented by Chemical Formula 1, a compound represented by Chemical Formula 2, or a combination thereof:
M¹X¹ [Chemical Formula 1]
wherein, in Chemical Formula 1, M¹ is Li⁺ or Na⁺, and X¹ is a monovalent anion with a radius of less than about 295 pm, and
M²²X² [Chemical Formula 2]
wherein, in Chemical Formula 2, M² is Li⁺ or Na⁺, and X² is a divalent anion with a radius of less than 295 pm.

8. The solid-liquid composite electrolyte of claim 1, wherein
the organic solvent includes a carbonate-based solvent, an ester-based solvent, an ether-based solvent, a ketone-based solvent, an alcohol-based solvent, an aprotic solvent, or a combination thereof.

9. The solid-liquid composite electrolyte of claim 1, wherein
the organic solvent includes a cyclic carbonate-based solvent, a halogenated ethylene carbonate-based solvent, a glyme-based solvent, a halogenated ether-based solvent, a nitrile-based solvent, or a combination thereof.

10. The solid-liquid composite electrolyte of claim 1, wherein
a molal concentration of the liquid electrolyte is about 0.5 m to about 20 m.

11. The solid-liquid composite electrolyte of claim 1, wherein
the sulfide-based solid electrolyte is in the form of particles, and the average particle diameter (D₅₀) of the particles is about 0.1 μm to about 5 μm.

12. The solid-liquid composite electrolyte of claim 1, wherein
the solid-liquid composite electrolyte includes an oxide-based solid electrolyte, a halide-based solid electrolyte, a complex hydride, or a combination thereof.

13. The solid-liquid composite electrolyte of claim 1, wherein
based on 100 vol % of the solid-liquid composite electrolyte, the sulfide-based solid electrolyte is included in an amount of about 10 vol % to about 99.99 vol % and the liquid electrolyte included in an amount of about 0.01 vol % to about 90 vol %.

14. The solid-liquid composite electrolyte of claim 1, wherein
based on 100 vol % of the solid-liquid composite electrolyte, the sulfide-based solid electrolyte is included in an amount of about 70 vol % to about 99.99 vol % and the liquid electrolyte included in an amount of about 0.01 vol % to about 30 vol %.

15. The solid-liquid composite electrolyte of claim 1, wherein
based on 100 vol % of the solid-liquid composite electrolyte, the sulfide-based solid electrolyte is included in an amount of about 85 vol % to about 99 vol % and the liquid electrolyte is included in an amount of about 1 vol % to about 15 vol %.

16. The solid-liquid composite electrolyte of claim 1, wherein
the solid-liquid composite electrolyte includes a plurality of sulfide-based solid electrolyte particles, and a liquid electrolyte in the pores between the particles.

17. A composite electrolyte film, comprising the solid-liquid composite electrolyte of claim 1.

18. A semi-solid rechargeable battery, comprising
a positive electrode,
a negative electrode, and
a composite electrolyte film of claim 16 between the positive electrode and the negative electrode.

19. The semi-solid rechargeable battery of claim 18, wherein
the positive electrode includes a positive electrode active material and of the solid-liquid composite electrolyte of claim 1.
